(19) United States
(12) Patent Application Publication
(10) Pub. No.: US 2025/0358906 A1
(43) Pub. Date: Nov. 20, 2025

(54) REFLECTOR CONFIGURATIONS FOR ENERGY FOCUSING IN PROCESSING CHAMBERS, AND RELATED CHAMBER KITS AND METHODS

(71) Applicant: Applied Materials, Inc., Santa Clara, CA (US)

(72) Inventors: Aniketnitin PATIL, San Jose, CA (US); Zuoming ZHU, Sunnyvale, CA (US)

(21) Appl. No.: 18/668,482

(22) Filed: May 20, 2024

(51) Int. Cl. H05B 3/00; H05B 3/02

(52) U.S. Cl. CPC H05B 3/0047; H05B 3/02; H05B 2203/032

(57) ABSTRACT

Embodiments of the present disclosure relate to reflector configurations for processing chambers, and related chamber kits and methods. In one or more embodiments, a processing chamber applicable for semiconductor manufacturing includes a substrate support disposed in a processing volume, and a reflector oriented to reflect energy toward the processing volume. The reflector includes one or more recessed surfaces, and a curved outer surface. The curved outer surface includes a first section extending radially outwardly relative to the one or more recessed surfaces, and a second section extending radially outwardly relative to the first section. The first section has a first radius of curvature, and the second section has a second radius of curvature. The curved outer surface includes a third section extending radially outwardly relative to the second section. The third section has a third radius of curvature larger than the second radius of curvature.

### BACKGROUND

### Field

Embodiments of the present disclosure relate to reflector configurations for processing chambers, and related chamber kits and methods.

### Description of the Related Art

Semiconductor substrates are processed for a wide variety of applications, including the fabrication of integrated devices and micro-devices. One method of processing substrates includes depositing a material, such as a dielectric material or a semiconductor material, on an upper surface of the substrate. The material may be deposited in a lateral flow chamber by flowing a process gas parallel to the surface of a substrate positioned on a support, and thermally decomposing the process gas to deposit a material from the gas onto the substrate surface.

However, operations (such as epitaxial deposition operations) can involve heating inefficiencies. For example, changes to chamber geometries can hinder thermal processing at certain areas, such as by reducing thermal peaks. As another example, it can be difficult to focus heating at certain areas. The heating difficulties can involve non-uniformities, which can involve hindered device performance and/or reduced throughput. For example, activation of gases can be limited and/or can involve non-uniform activation, which can cause limited and/or non-uniform film growth and/or dopant concentration. Such issues can be exacerbated in batch processing operations.

Therefore, a need exists for improved apparatuses and methods in semiconductor processing.

### SUMMARY

Embodiments of the present disclosure relate to reflector configurations for processing chambers, and related chamber kits and methods. In one or more embodiments, the reflector configurations focus heating toward a processing plane in a processing chamber. In one or more embodiments, a shield abuts the reflector.

In one or more embodiments, a reflector for disposition as part of a processing chamber includes a reflector face. The reflector face includes an inner surface disposed at a first height, and one or more recessed surfaces disposed outwardly of the inner surface. The reflector face includes a curved outer surface disposed outwardly of the one or more recessed surfaces. The curved outer surface extends to a second height that is larger than the first height.

In one or more embodiments, a chamber kit for disposition as part of a processing chamber includes a reflector. The reflector includes one or more recessed surfaces, and a curved outer surface disposed outwardly of the one or more recessed surfaces. The reflector includes an outer ledge disposed outwardly of the curved outer surface. The chamber kit includes a shield sized and shaped to abut the outer ledge of the reflector. The shield includes an inner surface oriented to intersect an outer end of the curved outer surface.

In one or more embodiments, a processing chamber applicable for semiconductor manufacturing includes a substrate support disposed in a processing volume, one or more heat sources operable to heat the processing volume, and a reflector oriented to reflect energy toward the processing volume. The reflector includes one or more recessed surfaces, and a curved outer surface disposed outwardly of the one or more recessed surfaces. The curved outer surface includes a first section extending radially outwardly relative to the one or more recessed surfaces, and a second section extending radially outwardly relative to the first section. The first section has a first radius of curvature, and the second section has a second radius of curvature. The curved outer surface includes a third section extending radially outwardly relative to the second section. The third section has a third radius of curvature larger than the second radius of curvature.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic cross-sectional side view of a processing chamber, according to one or more embodiments.

FIG. 2 is a schematic cross-sectional side view of the processing chamber shown in FIG. 1, according to one or more embodiments.

FIG. 3 is a schematic cross-sectional side view of a processing chamber, according to one or more embodiments.

FIG. 4 is a schematic partial enlarged view of the reflector and the shield shown in FIG. 1, according to one or more embodiments.

FIG. 5 is a schematic top view of the reflector shown in FIGS. 1-4, according to one or more embodiments.

FIG. 6 is a schematic top view of the reflector and the shield supported on the reflector shown in FIGS. 1-4, according to one or more embodiments.

FIG. 7 is a schematic perspective view of a linear lamp for use within the processing chamber of FIG. 1 and/or the processing chamber of FIG. 3, according to one or more embodiments.

FIG. 8 is a schematic perspective view of a curved lamp for use within the processing chamber of FIG. 1 and/or the processing chamber of FIG. 3, according to one or more embodiments.

FIG. 9 is a schematic block diagram view of a method of processing substrates for semiconductor manufacturing, according to one or more embodiments.

FIG. 10 is a schematic graphical view of believed irradiation versus substrate radius, using a configuration other than those described herein.

FIG. 11 is a schematic graphical view of believed irradiation versus substrate radius using subject matter described herein, according to one or more embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure relate to reflector configurations for processing chambers, and related chamber kits and methods. In one or more embodiments, the reflector configurations focus heating toward a processing plane in a processing chamber. In one or more embodiments, a shield abuts the reflector. The subject matter described herein can be used to process a single substrate at a time or two or more substrates simultaneously.

The disclosure contemplates that terms such as “couples,” “coupling,” “couple,” and “coupled” may include but are not limited to bonding, embedding, welding, fusing, melting together, interference fitting, threading, and/or fastening such as by using bolts, threaded connections, pins, and/or screws. The disclosure contemplates that terms such as “couples,” “coupling,” “couple,” and “coupled” may include but are not limited to integrally forming. The disclosure contemplates that terms such as “couples,” “coupling,” “couple,” and “coupled” may include but are not limited to direct coupling and/or indirect coupling, such as indirect coupling through components such as links, blocks, and/or frames.

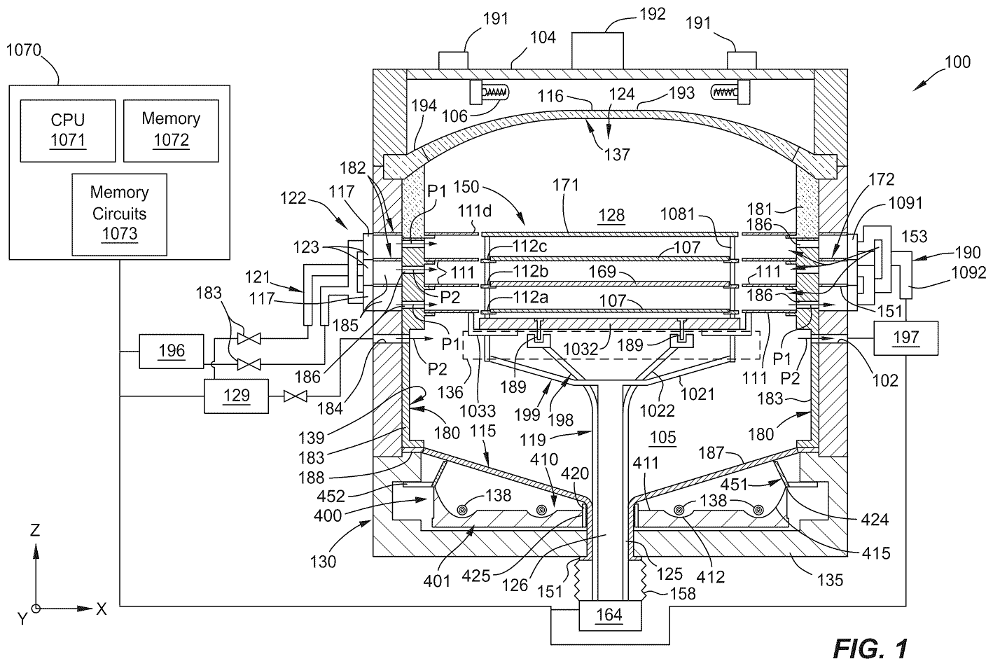

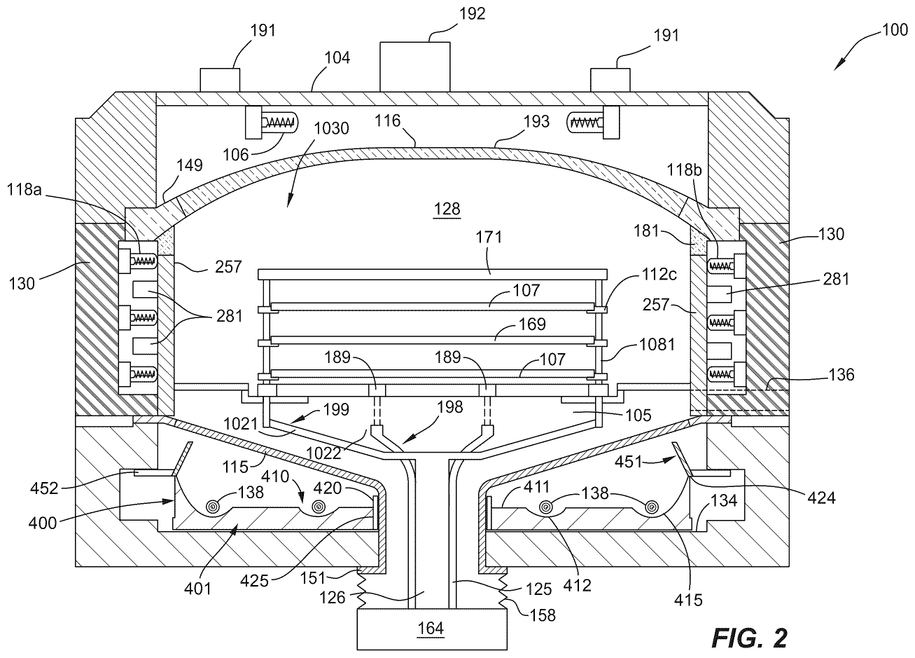

FIG. 1 is a schematic cross-sectional side view of a processing chamber 100, according to one or more embodiments. The side heat sources 118a, 118b shown in FIG. 2 are not shown in FIG. 1 for visual clarity purposes. The processing chamber 100 includes a processing chamber having a chamber body 130 that defines an internal volume 124. The internal volume 124 includes a processing volume 128.

A cassette 150 is positioned in the processing volume 128 and at least partially supported by a substrate support assembly 119 (such as a pedestal assembly). The cassette 150 includes a first plate 1032, a second plate 171, and a plurality of levels that support a plurality of substrates 107 (two are shown) for simultaneous processing (e.g., epitaxial deposition). The present disclosure contemplates that the first plate 1032 can be omitted. In the implementation shown in FIG. 1, the cassette 150 supports two substrates. The cassette 150 can support other numbers of substrates, including but not limited to three substrates 107, four substrates 107, six substrates 107, or eight or more substrates 107. The processing chamber 100 includes an upper plate 116, such as an upper window (for example, an upper dome), disposed between a lid 104 and the processing volume 128.

The processing chamber 100 includes a lower plate 115 (such as a lower window, for example a lower dome) disposed below the processing volume 128. One or more upper heat sources 106 are positioned above the processing volume 128 and the upper plate 116. The one or more upper heat sources 106 can be radiant heat sources such as lamps, for example halogen lamps. The one or more upper heat sources 106 are disposed between the upper plate 116 and the lid 104. The upper heat sources 106 are positioned to facilitate uniform heating of the substrates 107. One or more lower heat sources 138 are positioned below the processing volume 128 and the lower plate 115. The one or more lower heat sources 138 can be radiant heat sources such as lamps, for example halogen lamps. The lower heat sources 138 are disposed between the lower plate 115 and a floor 134 of the internal volume 124. The lower heat sources 138 are positioned to facilitate uniform heating of the substrates 107. A bias heat source 195 is oriented toward the first lift frame 199 and/or the second lift frame 198.

The present disclosure contemplates that other heat sources may be used (in addition to or in place of the lamps) for the various heat sources described herein. For example, resistive heaters, light emitting diodes (LEDs), and/or lasers may be used for the various heat sources described herein.

The upper and lower plates 116, 115 may be transparent to the infrared radiation, such as by transmitting at least 80% (such as at least 95%) of infrared radiation. The upper and lower plates 116, 115 may be a quartz material (such as a transparent quartz). In one or more embodiments, the upper plate 116 includes an inner transparent plate 193 and outer opaque supports 194. The inner plate 193 may be a thin quartz. The outer supports 194 support the inner plate 193 and are at least partially disposed within a support groove. In one or more embodiments, the lower plate 115 includes a transparent inner plate 187 and outer opaque supports 188. The inner plate 187 may be thin quartz. The outer supports 188 support the inner plate 187.

The substrate support assembly 119 is disposed in the processing volume 128. One or more liners 180 are disposed in the processing volume 128 and surround the substrate support assembly 119. The one or more liners 180 facilitate shielding the chamber body 130 from processing chemistry in the processing volume 128. The chamber body 130 is disposed at least partially between the upper plate 116 and the lower plate 115. The one or more liners 180 are disposed between the processing volume 128 and the chamber body 130. The one or more liners 180 include an upper liner 181 and one or more lower liners 183.

The processing chamber 100 includes one or more gas inject passages 182 formed in the chamber body 130 and in fluid communication with the processing volume 128, and one or more gas exhaust passages 172 (a plurality is shown in FIG. 1) formed in the chamber body 130 opposite the one or more gas inject passages 182. The one or more gas exhaust passages 172 are in fluid communication with the processing volume 128. Each of the one or more gas inject passages 182 and one or more gas exhaust passages 172 are formed through one or more sidewalls of the chamber body 130 and through the one or more liners 180 that line the one or more sidewalls of the chamber body 130.

Each gas inject passage 182 includes a gas channel 185 formed in the chamber body 130 and one or more gas openings 186 (one is shown in FIG. 1) formed in the one or more liners 180. One or more supply conduit systems are in fluid communication with the one or more gas inject passages 182. In FIG. 1, an inner supply conduit system 121 and an outer supply conduit system 122 are in fluid communication with a plurality of gas inject passages 182. The inner supply conduit system 121 includes an inner gas box 123 mounted to the chamber body 130 and in fluid communication with an inner set of the gas inject passages 182. The outer supply conduit system 122 includes a plurality of outer gas boxes 117 mounted to the chamber body 130 and in fluid communication with an outer set of the gas inject passages 182. The present disclosure contemplates that a variety of gas supply systems (e.g., supply conduit system(s), gas inject passages, and/or gas boxes different than what is shown in FIG. 1) may be used.

The processing chamber 100 includes a plurality of pre-heat rings 111a-111d positioned outwardly of the substrates 107 and the first and second plates 1032, 171. Four pre-heat rings 111a-111d are shown in FIG. 1. Other numbers (such as two or three) of the pre-heat rings 111 may be used. The pre-heat rings 11a-111d and the cassette 150 divide the processing volume into a plurality of flow levels 153 (three flow levels are shown in FIG. 1). In one or more embodiments, the processing chamber 100 includes at least two (such as at least three) flow levels 153. The one or more gas inject passages 182 are positioned as a plurality of inject levels such that each gas inject passage 182 corresponds to one of the plurality of inject levels. Each inject level aligns with a respective flow level 153. The pre-heat rings 111a-111d are coupled to and/or at least partially supported by the one or more liners 180. In one or more embodiments, the pre-heat rings 111a-111d each include a complete ring or one or more ring segments, such as a C-ring segment.

The cassette 150 includes a plurality of arcuate supports 112a-112c. A first arcuate support 112a is configured to support one of the substrates 107, a second arcuate support 112b, configured to support the plate 169, and a third arcuate support 112c the other of the substrates 107. The cassette 150 also includes one or more support rod structures 1081 (a plurality is shown) that support the arcuate supports 112a-112c. The one or more support rod structures 1081 sized and shaped to extend through the arcuate supports 112a-112c and into the second plate 171. In one or more embodiments, the arcuate supports 112a-112c each include a complete ring or one or more ring segments, such as a C-ring segment.

During operations (such as during an epitaxial deposition operation), one or more process gases P1 are supplied to the processing volume 128 through the outer supply conduit system 122, and through the one or more gas inject passages 182. The one or more process gases P1 are supplied from one or more gas sources 196 in fluid communication with the one or more gas inject passages 182. Each of the gas inject passages 182 is configured to direct the one or more processing gases P1 in a generally radially inward direction towards the cassette 150. As such, in one or more embodiments, the gas inject passages 182 may be part of a cross-flow gas injector. The flow(s) of the one or more process gases P1 can be divided into at least some of the plurality of flow levels 153. For at least the uppermost flow level 153 (or a single flow level 153—if a single flow level 153 is used), the one or more process gases P1 can be guided (using the second plate 171) along a streamlined flow path such that diversive flow away from the uppermost substrate 107 (or a single substrate 107—if a single substrate 107 is used) is reduced or eliminated.

The processing chamber 100 includes an exhaust conduit system 190. The one or more process gases P1 can be exhausted through exhaust gas openings formed in the one or more liners 180, exhaust gas channels formed in the chamber body 130, and then through exhaust gas boxes 1091. The one or more process gases P1 can flow from exhaust gas boxes 1091 and to an optional common exhaust box 1092, and then out through a conduit using one or more pump devices 197 (such as one or more vacuum pumps).

The one or more processing gases P1 can include, for example, purge gases, cleaning gases, and/or deposition gases. The deposition gases can include, for example, one or more reactive gases carried in one or more carrier gases. The one or more reactive gases can include, for example, silicon and/or germanium containing gases (such as silane (SiH₄), disilane (Si₂H₆), dichlorosilane (SiH₂Cl₂), and/or germane (GeH₄)), chlorine containing etching gases (such as hydrogen chloride (HCl)), and/or dopant gases (such as phosphine (PH₃) and/or diborane (B₂H₆)). The one or more purge gases can include, for example, one or more of argon (Ar), helium (He), nitrogen (N₂), hydrogen chloride (HCl), and/or hydrogen (H₂).

Purge gas P2 supplied from a purge gas source 129 is introduced to a bottom region 105 of the internal volume 124 through one or more purge gas inlets 184 formed in the sidewall of the chamber body 130. The purge gas P2 can also be supplied through the inner supply conduit system 121 and over a plate 169 positioned between the two substrates 107.

The one or more purge gas inlets 184 are disposed at an elevation below the one or more gas inject passages 182. If the one or more liners 180 are used, a section of the one or more liners 180 may be disposed between the one or more gas inject passages 182 and the one or more purge gas inlets 184. The one or more purge gas inlets 184 are configured to direct the purge gas P2 in a generally radially inward direction. The one or more purge gas inlets 184 may be configured to direct the purge gas P2 in an upward direction. During a film formation process, the substrate support assembly 119 is located at a position that can facilitate the purge gas P2 to flow generally along a flow path across a back side of the first plate 1032. The purge gas P2 exits the bottom region 105 and is exhausted out of the processing chamber 100 through one or more purge gas exhaust passages 102 located on the opposite side of the processing volume 128 relative to the one or more purge gas inlets 184.

The substrate support assembly 119 includes a first lift frame 199 and a second lift frame 198 disposed at least partially about the first lift frame 199. The first lift frame 199 includes first arms 1021 coupled to an outer ring 1033 such that lifting and lowering the first lift frame 199 lifts and lowers the substrates 107, the first plate 1032, the second plate 171, and the plate 169. A plurality of lift pins 189 are suspended from the first plate 1032. Lowering of the first plate 1032 and/or lifting of the second lift frame 198 initiates contact of the lift pins 189 with arms 1022 of the second lift frame 198. Continued lowering of the first plate 1032 and/or lifting of the second lift frame 198 initiates contact of the lift pins 189 with a substrate 107 and/or the plate 169 such that the lift pins 189 raise the substrate 107 and/or the plate 169. A bottom region 105 of the processing chamber 100 is defined between the floor 134 and the cassette 150. As shown in FIG. 1, the lift pins 189 can be configured to abut against—and be lifted from—the arms 1022.

A first shaft 126 of the first lift frame 199, a second shaft 125 of the second lift frame 198, and a section 151 of the lower plate 115 extend through a port formed in a bottom 135 of the chamber body 130 and the floor 134. Each shaft 125, 126 is coupled to one or more respective motors 164, which are configured to independently raise, lower, and/or rotate the substrates 107 and the plate 169 using the first lift frame 199, and to independently raise and lower the lift pins 189 using the second lift frame 198. The first lift frame 199 includes the first shaft 126 and a plurality of first arms 1021 configured to support the first plate 1032, the substrate supports 112, and the second plate 171.

The second lift frame 198 includes the second shaft 125 and the plurality of second arms 1022 configured to interface with and support the lift pins 189. A bellows assembly 158 circumscribes and encloses a portion of the shafts 125, 126 disposed outside the chamber body 130 to facilitate reduced or eliminated vacuum leakage outside the chamber body 130.

An opening 136 (a substrate transfer opening) is formed through the one or more sidewalls of the chamber body 130. The opening 136 may be used to transfer the plate 169 and/or the substrates 107 to or from the arcuate supports 112a-112c, e.g., in and out of the internal volume 124. In one or more embodiments, the opening 136 includes a slit valve. In one or more embodiments, the opening 136 may be connected to any suitable valve that enables the passage of substrates therethrough. The opening 136 is shown in ghost in FIGS. 1 and 2 for visual clarity purposes.

The processing chamber 100 may include one or more sensors 191, 192, 282, such as temperature sensors (e.g., optical pyrometers) or other metrology sensors, which measure temperatures (or other parameters) within the processing chamber 100 (such as on the surfaces of the upper plate 116, the first plate 1032, the second plate 171, the plate 169, the arcuate supports 112a-112c, the pre-heat rings 111a-111d, and/or the substrates 107). The one or more sensors 191, 192 are disposed on the lid 104. The one or more sensors 282 (e.g., lower pyrometers)—which are shown in FIG. 2—are disposed on a lower side of the lower plate 115. The one or more sensors 282 can be disposed adjacent to and/or on the bottom 135 of the chamber body 130.

In one or more embodiments, upper sensors 191, 192 are oriented toward a top of the second plate 171 and/or a top of a fourth pre-heat ring 111d. In one or more embodiments, side sensors 281 (e.g., side temperature sensors) are oriented toward one or more of the arcuate supports 112a-112c and/or the pre-heat rings 111a-111d. In one or more embodiments, lower sensors are oriented toward a bottom of the cassette 150 (such as a lower surface of the first plate 1032 and/or a bottom of the second plate 171), and/or a bottom of the first pre-heat ring 111a.

The processing chamber 100 includes a controller 1070 configured to control the processing chamber 100 or components thereof. For example, the controller 1070 may control the operation of components of the processing chamber 100 using a direct control of the components or by controlling controllers associated with the components. In operation, the controller 1070 enables data collection and feedback from the respective chambers to coordinate and control performance of the processing chamber 100.

The controller 1070 generally includes a central processing unit (CPU) 1071, a memory 1072, and support circuits 1073. The CPU 1071 may be one of any form of a general purpose processor that can be used in an industrial setting. The memory 1072, or non-transitory computer readable medium, is accessible by the CPU 1071 and may be one or more of memory such as random access memory (RAM), read only memory (ROM), floppy disk, hard disk, or any other form of digital storage, local or remote. The support circuits 1073 are coupled to the CPU 1071 and may include cache, clock circuits, input/output subsystems, power supplies, and the like.

The various methods (such as the method 1300) and operations disclosed herein may generally be implemented under the control of the CPU 1071 by the CPU 1071 executing computer instruction code stored in the memory 1072 (or in memory of a particular processing chamber) as, e.g., a software routine. When the computer instruction code is executed by the CPU 1071, the CPU 1071 controls the components of the processing chamber 100 to conduct operations in accordance with the various methods and operations described herein. In one or more embodiments, the memory 1072 (a non-transitory computer readable medium) includes instructions stored therein that, when executed, cause the methods (such as the method 900) and operations (such as the operations 902-912) described herein to be conducted. The controller 1070 can be in communication with the heat sources, the gas sources, and/or the vacuum pump(s) of the processing chamber 100, for example, to cause a plurality of operations to be conducted.

The first plate 1032, the substrate support 109, the second plate 171, and/or the one or more liners 180 (such as the upper liner 181 and/or the one or more lower liners 183), are formed of one or more of quartz (such as transparent quartz, e.g. clear quartz; opaque quartz, e.g. white quartz, or grey quartz; and/or black quartz), silicon carbide (SiC), graphite coated with SiC, and/or one or more ceramics (such as alumina (aluminum oxide (Al₂O₃)), Aluminum nitride (AlN), Silicon Nitride (Si₃N₄), Boron Nitride (BN), and/or Boron Carbide (B₄C)). In one or more embodiments, the first plate 1032, the substrate support 109, the second plate 171, and/or the one or more liners 180 include an opaque material. The opaque material is transmissive for 10% or less of light having a wavelength in the infrared (IR) range and/or the visible range. In one or more embodiments, the opaque material has an absorptivity that is at least 30% for light having a wavelength in the IR range and/or the visible range.

A chamber kit 400 of the processing chamber 100 includes a reflector 401 disposed below the substrate support 109. The lower heat sources 138 can be mounted to the reflector 401 and/or mounted through the reflector 401.

The reflector 401 includes a reflector face 410. The reflector 401 is oriented to reflect energy (such as radiation) toward one or more substrates 107, the cassette 150, and/or a substrate support and/or one or more plates 171, 1032 of the cassette 150. The reflector face 410 includes an inner surface 411 disposed at a first height H1, one or more recessed surfaces 412 (one is shown) disposed radially outwardly of the inner surface 411, and a curved outer surface 415 disposed radially outwardly of the one or more recessed surfaces 412. The one or more recessed surfaces 412 have a curved profile in the cross-section. The curved outer surface 415 extends to a second height H2 that is larger than the first height H1. The one or more recessed surfaces 412 and the curved outer surface 415 respectively have a curved profile in the cross-section shown in FIG. 1. In one or more embodiments, the one or more recessed surfaces 412 and the curved outer surface 415 respectively extend circumferentially about the inner surface 411. The reflector 401 includes an outer ledge 424 disposed outwardly of the curved outer surface 415. The inner surface 411 is part of an inner shoulder raised relative to the one or more recessed surfaces 412. The curved outer surface 415 and the outer ledge 424 are part of an outer shoulder raised relative to the one or more recessed surfaces 412. The inner shoulder has the first height H1 and the outer shoulder has the second height H2. The inner shoulder includes a central opening 425 formed in the inner surface 411 of the inner shoulder.

The chamber kit 400 includes a shield 451 sized and shaped to abut the outer ledge 424 of the reflector 401. The shield 451 rests on the outer ledge 424. The shield 451 includes one or more flanges 452 extending radially outwardly. The one or more flanges 452 can be coupled (such as fastened) to the chamber body 130.

The reflector 401 is shown as disposed below the cassette 150 and below the lower heat sources 138. The reflector 401 is shown as disposed below the cassette 150 and below the lower heat sources 138. The present disclosure contemplates, that in addition to or in place of the lower reflector 401 shown, the reflector 401 can be disposed above the upper plate 116 and between the lid 104 and the upper heat sources 106.

FIG. 2 is a schematic cross-sectional side view of the processing chamber 100 shown in FIG. 1, according to one or more embodiments. The cross-sectional view shown in FIG. 2 is rotated by 55 degrees relative to the cross-sectional view shown in FIG. 1.

The processing chamber 100 includes one or more side heat sources 118a, 118b (e.g., side lamps, side resistive heaters, side LEDs, and/or side lasers, for example) positioned outwardly of the processing volume 128. One or more second side heat sources 118b are opposite one or more first side heat sources 118a across the processing volume 128.

In FIG. 2, the pre-heat rings 111a-111d are not shown for visual clarity purposes. In addition to the one or more sensors 191, 192 positioned above the processing volume 128 and above the second plate 171, the processing chamber 100 may include one or more sensors 281, such as temperature sensors (e.g., optical pyrometers) or other metrology sensors, which measure temperatures (or other parameters) within the processing chamber 100. A plurality of transparent plates 257 (e.g., windows)—if used—can be disposed in gaps between or formed in the one or more liners 180 (such as the upper liner 181 and/or the one or more lower liners 183). The one or more sensors 281 are side sensors (e.g., side pyrometers) that are positioned outwardly of the processing volume 128, outwardly of the pre-heat rings 111a-111d (shown in FIG. 1), and outwardly of the plurality of plates 257. The one or more sensors 281 can be radially aligned, for example, with the plurality of plates 257 (as shown in FIG. 2).

The one or more side sensors 281 (such as one or more pyrometers) can be used to measure temperatures within the processing volume 128 from respective sides of the processing volume 128. The side sensors 281 are arranged in a plurality of sensor levels (two sensor levels are shown in FIG. 2). In one or more embodiments, the number of sensor levels is equal to the number of heat source levels. Each side sensor 281 can be oriented horizontally or can be directed (e.g., oriented downwardly at an angle) toward the substrate 107 and the substrate support 112 of a respective level of the cassette 150.

The present disclosure contemplates that the side heat sources 118a, 118b, the plates 257, and/or the side sensors 281 can be omitted.

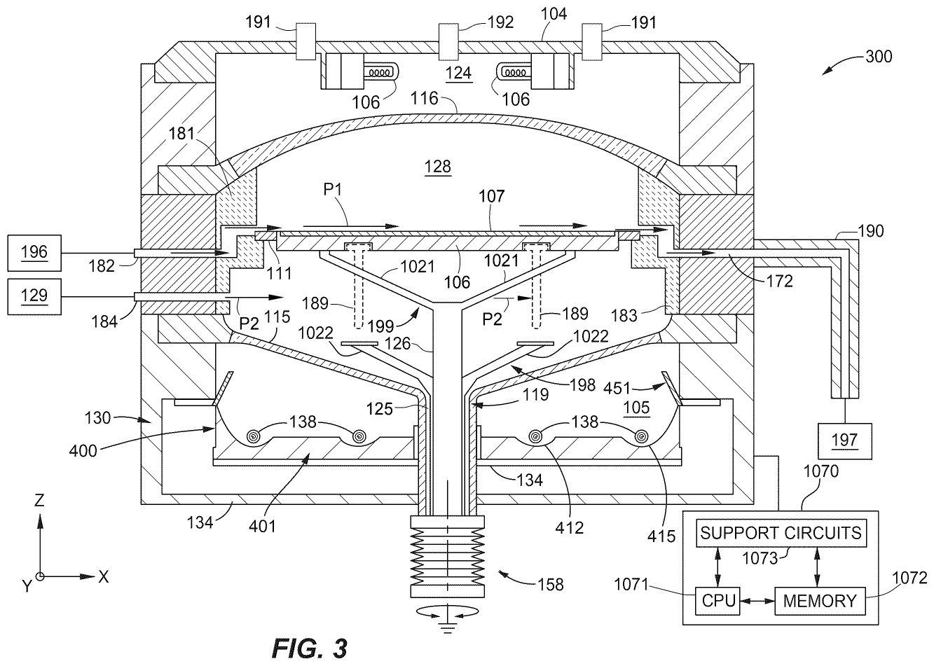

FIG. 3 is a schematic cross-sectional side view of a processing chamber 300, according to one or more embodiments. The processing chamber 300 is similar to the processing chamber 100 shown in FIG. 1, and includes one or more of the aspects, features, components, properties, and/or operations thereof. Some components in the processing chamber 100 may be omitted from the processing chamber 300. For example, parts of the cassette 150 can be omitted, and the processing chamber 300 includes one of the flow dividers 111 (e.g., a pre-heat ring) shown in FIG. 1.

The processing chamber 300 includes the first support frame 199 that supports a substrate support 109 configured to support a substrate 107. The substrate support 109 is coupled to and/or rests on the first arms 1021. As shown, the subject matter described herein can be used to process a single substrate 107 at a time in the processing chamber 300. During operations (such as during an epitaxial deposition operation), one or more process gases P1 are supplied to the processing volume 128 through the one or more gas inject passages 182 and flow over the substrate 107. The process gas G1 is then exhausted through the exhaust conduit system 190. In one or more embodiments, the substrate support 109 is a susceptor. Other substrate supports, such as a complete ring or one or more ring segments, are contemplated for the substrate support 109.

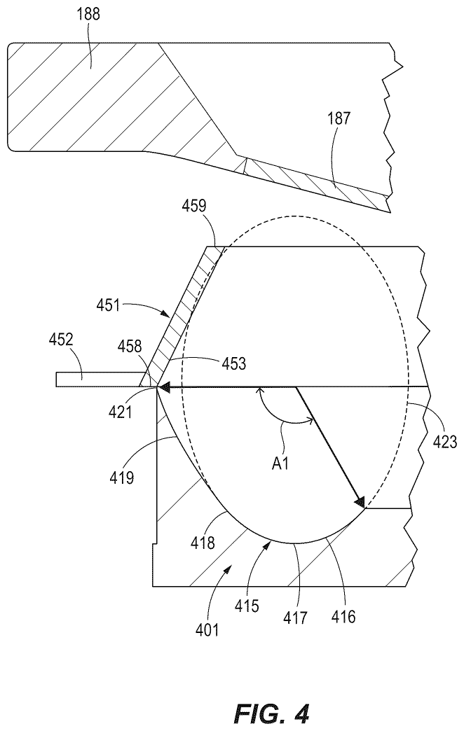

FIG. 4 is a schematic partial enlarged view of the reflector 401 and the shield 451 shown in FIG. 1, according to one or more embodiments. The shield 451 includes an inner surface 453 oriented to intersect an outer end 421 of the curved outer surface 415. In one or more embodiments, the inner surface 453 is angled (e.g., tapered) toward a point along the transparent inner plate 187 that is inwardly of the opaque supports 188. The curved outer surface 415 includes a first section 416 extending radially outwardly relative to the one or more recessed surfaces 412. The first section 416 has a first radius of curvature R1. The curved outer surface 415 includes a second section 417 extending radially outwardly relative to the first section 416. The second section 417 has a second radius of curvature R2. The shield 451 has a truncated cone shape that includes a first end 458 (e.g., a bottom end) sized and shaped to abut against the reflector 401, and a second end 459 (e.g., a top end) away from the reflector 401. The truncated cone is a hollow truncated cone. The first end 458 has a first diameter, and the second end 459 has a second diameter that is less than the first diameter. The first diameter and the second diameter can be measured, for example, relative to a central longitudinal axis of the shield 451.

The curved outer surface 415 includes a third section 418 extending radially outwardly relative to the second section 417. The third section 418 has a third radius of curvature R3. The first radius of curvature and/or the third radius of curvature R3 are larger than the second radius of curvature R2. In one or more embodiments, the third radius of curvature R3 and/or the first radius of curvature R1 are more than double the second radius of curvature R2. The curved outer surface 415 includes a fourth section 419 extending radially outwardly relative to the third section 418. The fourth section 419 has a fourth radius of curvature R4 larger than the third radius of curvature R3 and/or the first radius of curvature R1.

At least part of a profile of the curved outer surface 415 is part of an ellipse shape 423. In one or more embodiments, the first section 416, the second section 417, and the third section 418 are part of the ellipse shape 423, and the fourth section 419 has a larger radius of curvature to deviate from the ellipse shape 423. The profile of the curved outer surface 415 defines an azimuthal angle A1, and the azimuthal angle A1 is greater than 60 degrees. In one or more embodiments, the azimuthal angle A1 is greater than 80 degrees, such as 90 degrees or more. In one or more embodiments, the azimuthal angle A1 is within a range of 90 degrees to 120 degrees. The azimuthal angle A1 can be measured from a center of the ellipse shape 423. In one or more embodiments, the azimuthal angle A1 is at least double the azimuthal angle of at least one of the one or more recessed surfaces 412. In one or more embodiments, the curved outer surface 415 has a surface area that is at least 40% larger (such as at least 50% larger) than a surface area of at least one of the one or more recessed surfaces 412.

The inner surface 411, the one or more recessed surfaces 412, the curved outer surface 415, and/or the inner surface 453 are formed of a reflective material. In one or more embodiments, the reflective material is gold. Other reflective materials (such as copper, nickel, brass, bronze, silver, gold, aluminum, or an alloy thereof) are contemplated. The reflective material can be polished, such as polished aluminum. In one or more embodiments, the reflective material is disposed (e.g., coated) over a metallic body. The metallic body can include, for example, aluminum and/or stainless steel.

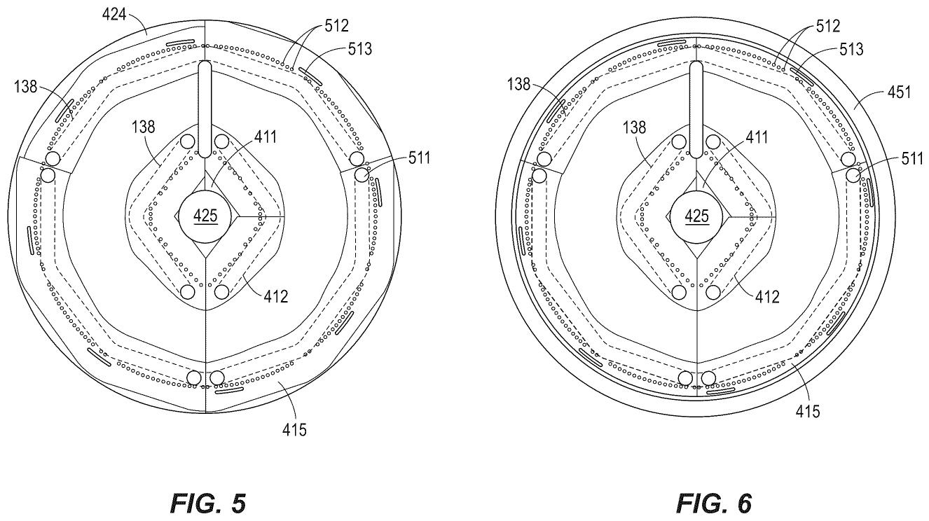

FIG. 5 is a schematic top view of the reflector 401 shown in FIGS. 1-4, according to one or more embodiments.

The one or more recessed surfaces 412 and the curved outer surface 415 can be defined by a plurality of grooves formed in the reflector 401. The plurality of grooves are respectively configured to hold one or more horizontal heat sources 138 (such as linear heat sources) extending along the direction of the respective groove. Some of the heat sources 138 are shown in ghost in FIG. 5 for visual clarity purposes. The plurality of grooves are arranged to form concentric rings. The concentric rings can be hexagonal in shape.

The one or more recessed surfaces 412 and the curved outer surface 415 respectively include a set of first openings 511 having a first diameter, a set of second openings 512 having a second diameter smaller than the first diameter, and a set of slots 513 (e.g., elongated slots) having a length larger than the first diameter and the second diameter. The present disclosure contemplates that the second diameter can vary for the second openings 512. The first openings 511 allow an electrical connection and/or mechanical connection of the heat sources 138 to be disposed therethrough. A cooling fluid (such as air) can be flowed through the second openings 512 and/or the slots 513 to cool the lower plate 115, the reflector 401, and/or the heat sources 138. A slot 515 (e.g., an elongated slot) is formed in the reflector 401. The slot 515 can allow sensor device(s) (such as pyrometer(s)) to take measurements through the slot 515. For example, the slot 515 can provide a line of sight to at least one substrate 107, the first plate 1032 shown in FIG. 1, and/or the substrate support 106 shown in FIG. 3. In one or more embodiments, the slot 515 extends at least partially into the curved outer surface 415 and at least one of the one or more recessed surfaces 412. The present disclosure contemplates that the inner surface 411, the one or more recessed surfaces 412, the curved outer surface 415, and/or the outer ledge 424 can respectively be divided into multiple sections, as shown in FIG. 5.

FIG. 6 is a schematic top view of the reflector 401 and the shield 451 supported on the reflector 401 shown in FIGS. 1-4, according to one or more embodiments.

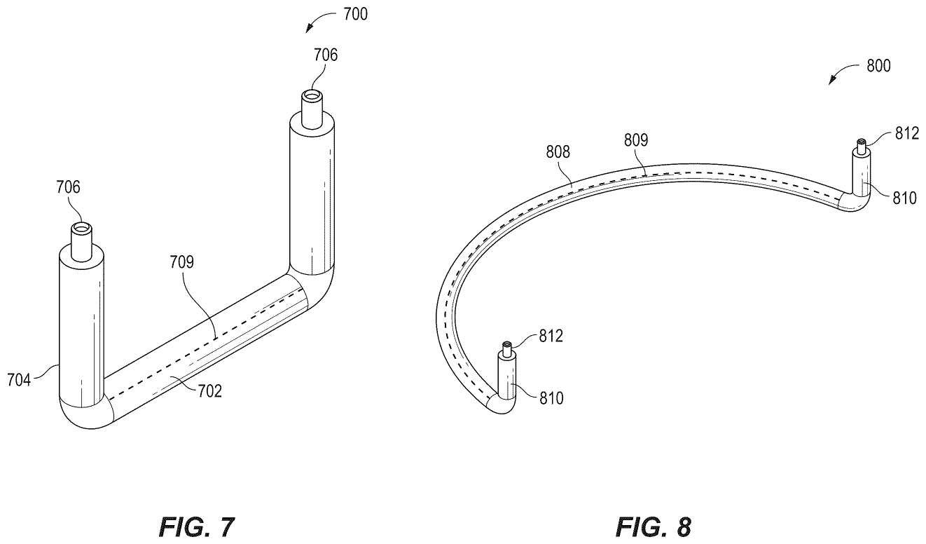

FIG. 7 is a schematic perspective view of a linear lamp 700 for use within the processing chamber 100 of FIG. 1 and/or the processing chamber 300 of FIG. 3, according to one or more embodiments. As an example the linear lamp 700 can be used as the upper heat sources 106 and/or the lower heat sources 138. The linear lamp 700 includes a linear bulb 702, one or more arms 704, and one or more electrical connections 706. In one or more embodiments, the linear lamps 700 are infrared (IR) halogen lamps. The linear bulb 702 is a cylindrical bulb with a filament 709 disposed therein. The linear bulb 702 is configured to emit a radiative energy, such as IR light, towards the substrate 107 when positioned within the processing chamber.

The one or more arms 704 extend from the linear bulb 702. As shown in FIG. 7, there are two arms 704 and one arm extends from each distal end of the linear bulb 702. The two arms 704 can extend in a direction perpendicular to the direction in which the linear bulb 702 extends. The present disclosure contemplates that the two arms 704 can extend obliquely relative to the linear bulb 702 to extend through an angled orientation of the first openings 511 shown in FIGS. 5 and 6. The two arms 704 can extend in the same direction or can be angled to extend in opposite directions. At the end of each of the arms 704 is an electrical connection 706. The electrical connection 706 is configured to be plugged into or coupled to a socket or other power source. The electrical connections 706 are electrically coupled to the filament 709 within the linear bulb 702 and enable the linear lamp 700 to be powered.

FIG. 8 is a schematic perspective view of a curved lamp 800 for use within the processing chamber 100 of FIG. 1 and/or the processing chamber 300 of FIG. 3, according to one or more embodiments.

The curved lamp 800 includes a curved bulb 808, one or more arms 810, and one or more electrical connections 812. The curved bulb 808 is a tubular bulb shaped to form at least a portion of a ring, such as an arcuate ring. The curved bulb 808 includes a filament 809 disposed therein. The curved bulb 808 is configured to emit a radiative energy towards the substrate 107 when positioned within the processing chamber.

The one or more arms 810 extend from the curved bulb 808. As shown in FIG. 8, there are two arms 810, and one arm extends from each distal end of the curved bulb 808. The arms 810 can extend orthogonally or obliquely to a plane of the curved bulb 808. The two arms 810 extend in a direction perpendicularly or obliquely to the direction in which the curved bulb 808 extends. The two arms 810 can extend in the same direction are can be angled to extend in opposite directions. The arms 810 extend through the first openings 511 of the reflector 401. At the end of each of the arms 810 is an electrical connection 812. The electrical connection 812 is configured to be plugged into or coupled to a socket or other power source. The electrical connections 812 are electrically coupled to a filament 809 within the curved bulb 808 and enable the curved lamp 800b to be powered.

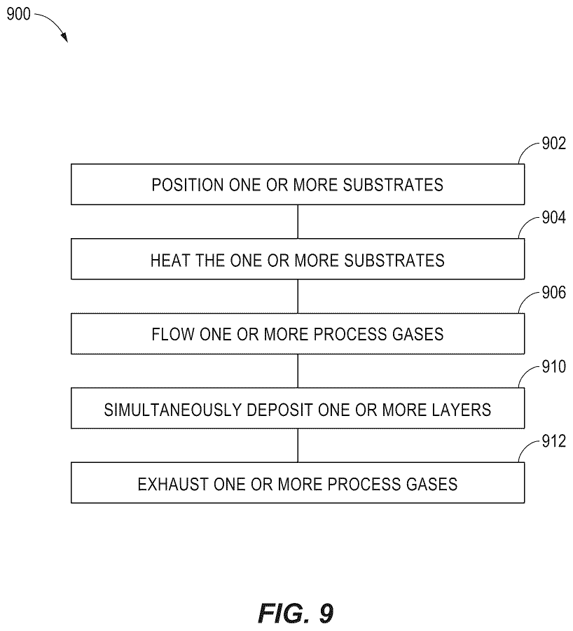

FIG. 9 is a schematic block diagram view of a method 900 of processing substrates for semiconductor manufacturing, according to one or more embodiments.

Operation 902 of the method 900 includes positioning one or more substrates in a processing volume of a chamber. In one or more embodiments, the one or more substrates are positioned on one or more substrate supports.

Operation 904 includes heating the one or more substrates. It is contemplated that operation 904 may occur prior to, subsequent to, and/or concurrent with operation 906.

Operation 906 includes flowing one or more process or inert gases into the processing volume.

Operation 910 includes simultaneously depositing or baking one or more layers respectively on the one or more substrates. In one or more embodiments, the baking includes hydrogen (H₂) to remove moisture and/or impurities from the substrate.

Operation 912 includes exhausting the one or more process or inert gases from the processing volume. During the flowing of operation 906 and/or the exhausting of operation 912, the one or more process or inert gases can follow the flow paths described herein (such as the flow paths described in relation to FIGS. 1, 2 and/or 3).

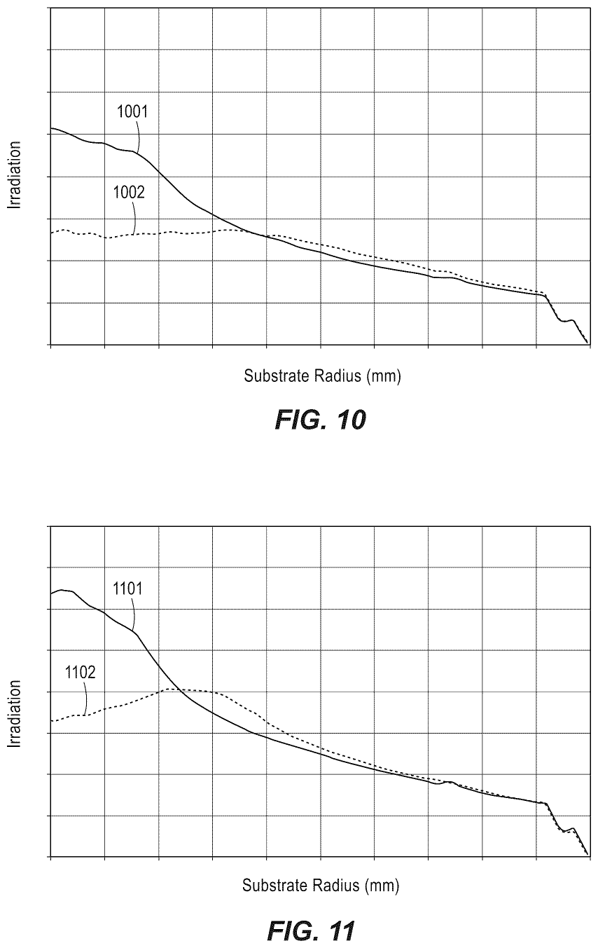

FIG. 10 is a schematic graphical view of believed irradiation versus substrate radius, using a configuration other than those described herein.

A first profile 1001 shows irradiation for a first zone of heat sources, and a second profile 1002 shows irradiation for a second zone of heat sources.

FIG. 11 is a schematic graphical view of believed irradiation versus substrate radius using subject matter described herein, according to one or more embodiments.

A first profile 1101 shows irradiation for a first zone of heat sources, and a second profile 1102 shows irradiation for a second zone of heat sources. The first profile 1101 can correspond, for example, to one half of the innermost recessed surface 312 shown in FIGS. 5 and 6. The second profile 1102 can correspond, for example, to another half of the innermost recessed surface 312 shown in FIGS. 5 and 6. As shown by comparing FIGS. 11 and 10, the subject matter described herein facilitates higher heating peaks for the first and second profiles 1101, 1102 in FIG. 11. The higher heating peaks can be achieved for inner zones and outer zones of substrates.

Benefits of the present disclosure include heat efficiency and enhanced thermal processing; increased thermal peaks at various substrate zones for a variety of chamber geometries; enhanced focusing of heating at processing plane(s) of substrate(s). Benefits also include higher film growth rates; higher dopant concentrations; more uniform heating; and more uniform film growth rates and/or dopant concentrations. Benefits further include increased throughput; enhanced heat source lifespans; reduced heat cycles; enhanced device performance; thermal control and adjustability for zones; and quick and efficient heating of zones.

Such benefits can be facilitated for processing a single substrate at a time, and/or batch processing a plurality of substrates simultaneously. For example, film growth rate uniformity and/or dopant concentration uniformity can be enhanced across substrates processed using batch processing

It is contemplated that one or more aspects disclosed herein may be combined. As an example, one or more aspects, features, components, operations, and/or properties of the various implementations of the processing chamber 100, the cassette 150, the one or more of the heat sources 106, 138, the chamber kit 400, the reflector 401, the shield 451, the processing chamber 300, the linear lamp 700, the curved lamp 800, and/or the method 900 may be combined. Moreover, it is contemplated that one or more aspects disclosed herein may include some or all of the aforementioned benefits.

While the foregoing is directed to embodiments of the present disclosure, other and further embodiments of the disclosure may be devised without departing from the basic scope thereof, and the scope thereof is determined by the claims that follow.

1. A reflector for disposition as part of a processing chamber, the reflector comprising:
a reflector face comprising:
an inner surface disposed at a first height,
one or more recessed surfaces disposed outwardly of the inner surface, and
a curved outer surface disposed outwardly of the one or more recessed surfaces, the curved outer surface extending to a second height that is larger than the first height.

2. The reflector of claim 1, wherein the curved outer surface comprises:
a first section extending radially outwardly relative to the one or more recessed surfaces, the first section having a first radius of curvature;
a second section extending radially outwardly relative to the first section, the second section having a second radius of curvature; and
a third section extending radially outwardly relative to the second section, the third section having a third radius of curvature.

3. The reflector of claim 2, wherein the first radius of curvature and the third radius of curvature are larger than the second radius of curvature.

4. The reflector of claim 3, wherein the third radius of curvature is more than double the second radius of curvature.

5. The reflector of claim 1, wherein at least part of a profile of the curved outer surface is part of an ellipse.

6. The reflector of claim 5, wherein the profile of the curved outer surface defines an azimuthal angle, and the azimuthal angle is greater than 60 degrees.

7. The reflector of claim 1, wherein the curved outer surface is formed of gold.

8. The reflector of claim 1, wherein the curved outer surface has a surface area that is at least 40% larger than a surface area of at least one of the one or more recessed surfaces.

9. The reflector of claim 1, wherein the curved outer surface comprises:
a set of first openings having a first diameter;
a set of second openings having a second diameter smaller than the first diameter; and
a set of slots having a length larger than the first diameter and the second diameter.

10. A chamber kit for disposition as part of a processing chamber, the chamber kit comprising:
a reflector comprising:
one or more recessed surfaces, and
a curved outer surface disposed outwardly of the one or more recessed surfaces, and
an outer ledge disposed outwardly of the curved outer surface; and
a shield sized and shaped to abut the outer ledge of the reflector, the shield comprising an inner surface oriented to intersect an outer end of the curved outer surface.

11. The chamber kit of claim 10, wherein the reflector further comprises an inner shoulder raised relative to the one or more recessed surfaces, and the curved outer surface and the outer ledge are part of an outer shoulder raised relative to the one or more recessed surfaces.

12. The chamber kit of claim 11, wherein the inner shoulder has a first height, and the outer shoulder has a second height that is larger than the first height, and the reflector further comprises a central opening formed in the inner shoulder.

13. The chamber kit of claim 10, wherein the shield has a truncated cone shape comprising:
a first end sized and shaped to abut against the reflector, the first end having a first diameter; and
a second end away from the reflector, the second end having a second diameter that is less than the first diameter.

14. The chamber kit of claim 10, wherein the curved outer surface comprises:
a first section extending radially outwardly relative to the one or more recessed surfaces, the first section having a first radius of curvature;
a second section extending radially outwardly relative to the first section, the second section having a second radius of curvature; and
a third section extending radially outwardly relative to the second section, the third section having a third radius of curvature.

15. The chamber kit of claim 14, wherein the third radius of curvature is more than double the second radius of curvature.

16. A processing chamber applicable for semiconductor manufacturing, comprising:
a substrate support disposed in a processing volume;
one or more heat sources operable to heat the processing volume; and
a reflector oriented to reflect energy toward the processing volume, the reflector comprising:
one or more recessed surfaces, and
a curved outer surface disposed outwardly of the one or more recessed surfaces, the curved outer surface comprising:
a first section extending radially outwardly relative to the one or more recessed surfaces, the first section having a first radius of curvature,
a second section extending radially outwardly relative to the first section, the second section having a second radius of curvature, and
a third section extending radially outwardly relative to the second section, the third section having a third radius of curvature larger than the second radius of curvature.

17. The processing chamber of claim 16, wherein the curved outer surface of the reflector further comprises:
a fourth section extending radially outwardly relative to the third section, the fourth section having a fourth radius of curvature larger than the third radius of curvature.

18. The processing chamber of claim 16, wherein the reflector further comprises:
an outer ledge disposed outwardly of the curved outer surface.

19. The processing chamber of claim 18, further comprising:
a shield abutting the outer ledge of the reflector, the shield intersecting an outer end of the curved outer surface.

20. The processing chamber of claim 18, wherein the reflector further comprises an inner shoulder raised relative to the one or more recessed surfaces, and the curved outer surface and the outer ledge are part of an outer shoulder raised relative to the one or more recessed surfaces, wherein the inner shoulder has a first height, and the outer shoulder has a second height that is larger than the first height.
